(19) United States
(12) Patent Application Publication
(10) Pub. No.: US 2025/0164637 A1
(43) Pub. Date: May 22, 2025

(54) METHOD AND SYSTEM FOR DETECTING ULTRASOUNIC SENSOR OBSTRUCTION

(71) Applicant: INVENSENSE, INC, San Jose, CA (US)

(72) Inventors: Agnes Gomez, Grenoble (FR); Joe Youssef, Noyarey (FR)

(21) Appl. No.: 18/617,478

(22) Filed: Mar. 26, 2024

Related U.S. Application Data
(60) Provisional application No. 63/601,616, filed on Nov. 21, 2023.

(51) Int. Cl. G01S 15/04; G01S 7/52

(52) U.S. Cl. CPC G01S 15/04; G01S 7/52026

(57) ABSTRACT

Methods and systems are disclosed for a method for determining an ultrasonic sensor is obstructed. Returned signals from a plurality of emitted ultrasonic pulses of an ultrasonic transducer are evaluated. Detection of an obstruction characteristic leads to a determination that the ultrasonic transducer is obstructed.

### CROSS-REFERENCE TO RELATED APPLICATIONS

This application claims priority to U.S. Provisional Patent Application No. 63/601,616, filed Nov. 21, 2023, the content of which is incorporated by reference in its entirety.

### FIELD OF THE PRESENT DISCLOSURE

This invention relates to the operation of an ultrasonic transducer and more particularly to determine when the sensor may be obstructed.

### BACKGROUND

A variety of devices exist which utilize sonic sensors (e.g., sonic emitters and receivers, or sonic transducers). By way of example, and not of limitation, a device may utilize one or more sonic sensors to track the location of the device in space, to detect the presence of objects in the environment of the device, and/or to avoid objects in the environment of the device. Such sonic sensors include transmitters which transmit sonic signals, receivers which receive sonic signals, and transducers which both transmit sonic signals and receive sonic signals. Many of these sonic transducers emit signals in the ultrasonic range, and thus may be referred to as ultrasonic transducers. Piezoelectric Micromachined Ultrasonic Transducers (PMUTs), which may be air-coupled, are one type of sonic transducer which operates in the ultrasonic range. Sonic transducers, including ultrasonic transducers, can be used for a large variety of sensing applications such as, but not limited to: virtual reality controller tracking, presence detection, object detection/location, and object avoidance. For example, drones, robots, security systems or other devices may use ultrasonic transducers and/or other sonic transducers in any of these or numerous other applications.

For example, devices such as laptop computers, smartphones, tablets, virtual reality headsets, smart watches, activity trackers and other devices are increasingly likely to be equipped with ultrasonic sensors to achieve these and other functions. However, because these devices are often portable and there are many common circumstances when they may be carried by a user or placed in a pocket or bag so that the ultrasonic sensor becomes obstructed. Even when the device is in a relatively static configuration, such as a laptop on a user's desk, other objects can be placed or move in front of the sensor and likewise cause obstruction. As will be appreciated, there are numerous other situations in which the ultrasonic sensor of a device becomes temporarily obstructed. As such, it would be desirable to provide systems and methods for determining when the sensor is obstructed and not giving accurate information about its environment. As will be described in the following materials, the techniques of this disclosure satisfy this and other needs.

### SUMMARY

The disclosure is directed to a device having an ultrasonic transducer configured to emit an ultrasonic pulse and receive returned signals corresponding to the emitted ultrasonic pulse and at least one processor coupled with the ultrasonic transducer. The at least one processor may be configured to evaluate returned signals from a first plurality of emitted ultrasonic pulses, detect an obstruction characteristic based on the evaluation and determine the ultrasonic transducer is obstructed based on the detected obstruction characteristic.

Further, this disclosure also is directed to a sensor processing unit having an ultrasonic transducer configured to emit an ultrasonic pulse and receive returned signals corresponding to the emitted ultrasonic pulse and at least one sensor processor coupled with the ultrasonic transducer and configured to evaluate returned signals from a first plurality of emitted ultrasonic pulses, detect an obstruction characteristic based on the evaluation and determine the ultrasonic transducer is obstructed based on the detected obstruction characteristic.

This disclosure is also directed to a method for determining an ultrasonic sensor is obstructed. The method may involve evaluating with at least one processor coupled with an ultrasonic transducer returned signals from a first plurality of emitted ultrasonic pulses, detecting an obstruction characteristic based on the evaluation and determining the ultrasonic transducer is obstructed based on the detected obstruction characteristic.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIGS. 1A and 1B show example block diagrams of some aspects of a device which includes a sonic transducer, in accordance with various embodiments.

FIG. 2 shows an example external depiction of a device using an ultrasonic transducer configured to determine when it may be obstructed, in accordance with various embodiments.

FIG. 3 illustrates a flow diagram of a method of detecting obstruction of an ultrasonic transducer, in accordance with various embodiments.

FIG. 4 illustrates a graph of returned signals exhibiting an absence of signal beyond the noise level, in accordance with various embodiments.

FIG. 5 illustrates graphs showing use of an absence of signal beyond the noise level to determine obstruction, in accordance with various embodiments.

FIG. 6 illustrates a graph of returned signals exhibiting ringdown amplitude variation, in accordance with various embodiments.

FIG. 7 illustrates graphs showing use of ringdown amplitude variation to determine obstruction, in accordance with various embodiments.

FIG. 8 illustrates a graph of returned signals exhibiting signal saturation, in accordance with various embodiments.

FIG. 9 illustrates graphs showing use of signal saturation to determine obstruction, in accordance with various embodiments.

### DETAILED DESCRIPTION

At the outset, it is to be understood that this disclosure is not limited to particularly exemplified materials, architectures, routines, methods or structures as such may vary. Thus, although a number of such options, similar or equivalent to those described herein, can be used in the practice or embodiments of this disclosure, the preferred materials and methods are described herein.

It is also to be understood that the terminology used herein is for the purpose of describing particular embodiments of this disclosure only and is not intended to be limiting.

The detailed description set forth below in connection with the appended drawings is intended as a description of exemplary embodiments of the present disclosure and is not intended to represent the only exemplary embodiments in which the present disclosure can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the specification. It will be apparent to those skilled in the art that the exemplary embodiments of the specification may be practiced without these specific details. In some instances, well known structures and devices are shown in block diagram form in order to avoid obscuring the novelty of the exemplary embodiments presented herein.

For purposes of convenience and clarity only, directional terms, such as top, bottom, left, right, up, down, over, above, below, beneath, rear, back, and front, may be used with respect to the accompanying drawings or chip embodiments. These and similar directional terms should not be construed to limit the scope of the disclosure in any manner.

In this specification and in the claims, it will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the exemplary wireless communications devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor. For example, a carrier wave may be employed to carry computer-readable electronic data such as those used in transmitting and receiving electronic mail or in accessing a network such as the Internet or a local area network (LAN). Of course, many modifications may be made to this configuration without departing from the scope or spirit of the claimed subject matter.

The various illustrative logical blocks, modules, circuits and instructions described in connection with the embodiments disclosed herein may be executed by one or more processors, such as one or more sensor processing units (SPUs), digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of a Motion Processor Unit (MPU) or Sensor Processing Unit (SPU) and a microprocessor, a plurality of microprocessors, one or more microprocessors in conjunction with an MPU/SPU core, or any other such configuration.

Unless defined otherwise, all technical and scientific terms used herein have the same meaning as commonly understood by one having ordinary skill in the art to which the disclosure pertains.

Finally, as used in this specification and the appended claims, the singular forms “a, “an” and “the” include plural referents unless the content clearly dictates otherwise.

Sonic transducers, which include ultrasonic transducers, emit a pulse (e.g., an ultrasonic sound) and then receive returned signals (i.e., echoes) after the ultrasonic waves from the emitted sound are reflected of objects or persons. In this manner, the returned signals correspond to the emitted pulse. In such a transducer, the returned signals can be used to detect the presence and/or location of objects from which the emitted pulse reflects and then returns to the transducer as a returned signal. In other instances, a first ultrasonic transducer may emit a pulse and the echoing returned signals are received by a second ultrasonic transducer. As discussed above, an ultrasonic transducer of a device may be used to detect the presence of a user to draw an inference that the user is interacting with the device and manage its operation accordingly. As one non-limiting example, the device may be a computing device such as a laptop computer. When the user is interacting with the laptop, it would be desirable to avoid entering a power save mode or otherwise manage operation of the device. A user presence detection algorithm may use information from the ultrasonic sensor to determine a user is in proximity and correspondingly infer the user is interacting with the device. However, if the ultrasonic transducer is blocked, such as by the way the user is holding or carrying the device of if the device is temporarily placed in a bag or other container, the ability to sense the presence of the user is compromised and this may lead to the erroneous conclusion that the user is not present. Again, in the context of the example above, this may cause the device to undesirably enter a power save mode. Accordingly, the techniques of this disclosure are directed to detecting that the ultrasonic transducer is obstructed and therefore should not be relied upon to determine whether a user is present. One of ordinary skill in the art will also appreciate that there any number of other contexts that would benefit from detecting obstruction so that it may be determined the ultrasonic transducer is unable to reliably sense its environment.

Herein, a variety of methods, sonic transducers, devices, and techniques are described for detecting obstruction of the ultrasonic transducer. Although this technology is described herein with reference to ultrasonic transducers, it is broadly applicable to any sonic transducer which might be similarly utilized. In the detailed description, the technology is described with examples in which sonic pulses are emitted and received by a single transducer, however the technology may be implemented with a transducer which emits sonic pulses and one or more other transducers which receive returned signals that result from the emissions. Though the sensed environment where detection of obstruction objects takes place is often referred to as a room or indoor space in this detailed description, it should be appreciated that the techniques described are applicable to other environments.

Discussion begins with a description of notation and nomenclature. Discussion then shifts to description of some block diagrams of example components of an example devices and a sensor processing unit which may utilize an ultrasonic transducer (or other sonic transducer). The device may be any type of device which utilizes sonic sensing, for example any device which uses ultrasonic transducers may employ the techniques and methods described herein. Discussion then moves to description of a device using a sonic transducer to detect for objects in an environment and within a distance range of interest from the ultrasonic transducer. Returned signals from an emitted pulse are discussed along with methods for utilizing the returned signals to detect a obstruction object in an environment of the sonic transducer. Finally, operation of the device, sensor processor, and/or components thereof are described in conjunction with description of a method of detecting obstruction of an ultrasonic transducer.

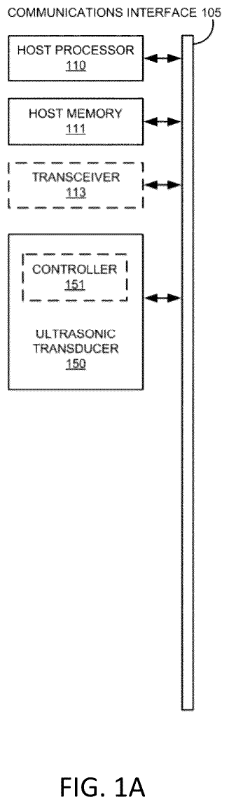

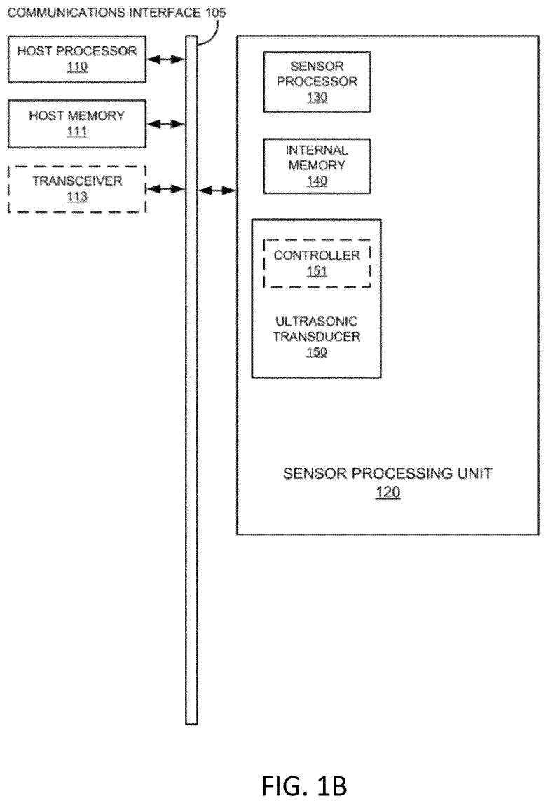

FIGS. 1A and 1B show example block diagrams of some aspects of a device 100 which includes a sonic transducer such as ultrasonic transducer 150, in accordance with various embodiments. Some examples of a device 100 may include, but are not limited to: a desktop or laptop computer, a smart phone, a tablet, a security system, a child monitor, and similar devices. These devices may be generally classified as “moving devices” and “non-moving devices.” A non-moving device is one which is intended to be placed and then remain stationary in that place (e.g., a security sensor). A moving device is one which is self-mobile (e.g., a drone or delivery robot) or which may be moved easily by a human (e.g., a laptop computer). By way of example, and not of limitation, the device 100 may utilize one or more ultrasonic transducers 150 to detect the presence of objects in the environment of the device 100 or to sense the absence of objects in the environment of device 100 in order to detect obstruction of ultrasonic transducer 150.

FIG. 1A shows a block diagram of components of an example device 100A, in accordance with various aspects of the present disclosure. As shown, example device 100A comprises a communications interface 105, a host processor 110, host memory 111, and at least one ultrasonic transducer 150. In some embodiments, device 100 may additionally include one a transceiver 113. Though not depicted, some embodiments of device 100A may include one or more additional sensors used to detect motion, position, or environmental context. Some examples of these additional sensors may include, but are not limited to: inertial motion sensors such as gyroscopes and accelerometers, infrared sensors, cameras, microphones, atmospheric pressure sensors, temperature sensors, and global navigation satellite system sensors (i.e., a global positioning system receiver). As depicted in FIG. 1A, included components are communicatively coupled with one another, such as, via communications interface 105.

The host processor 110 may, for example, be configured to perform the various computations and operations involved with the general function of a device 100. Host processor 110 can be one or more microprocessors, central processing units (CPUs), DSPs, general purpose microprocessors, ASICs, ASIPs, FPGAs or other processors which run software programs or applications, which may be stored in host memory 111, associated with the general and conventional functions and capabilities of device 100. In some embodiments, a host processor 110 may perform some amount of the processing of received returned signals from ultrasonic transducer 150 and/or some aspects of the methods of detecting obstruction that are described herein.

Communications interface 105 may be any suitable bus or interface, such as a peripheral component interconnect express (PCIe) bus, a universal serial bus (USB), a universal asynchronous receiver/transmitter (UART) serial bus, a suitable advanced microcontroller bus architecture (AMBA) interface, an Inter-Integrated Circuit (I2C) bus, a serial digital input output (SDIO) bus, or other equivalent and may include a plurality of communications interfaces. Communications interface 105 may facilitate communication between a sensor processing unit (SPU) 120 (see e.g., FIG. 1B) and one or more of host processor 110, host memory 111, transceiver 113, ultrasonic transducer 150, and/or other included components.

Host memory 111 may comprise programs, modules, applications, or other data for use by host processor 110. In some embodiments, host memory 111 may also hold information that that is received from or provided to SPU 120 (see e.g., FIG. 1B). Host memory 111 can be any suitable type of memory, including but not limited to electronic memory (e.g., read only memory (ROM), random access memory (RAM), or other electronic memory). Host memory 111 may include instructions to implement one or more of the methods described herein using host processor 110 and ultrasonic transducer 150.

Transceiver 113, when included, may be one or more of a wired or wireless transceiver which facilitates receipt of data at device 100 from an external transmission source and transmission of data from device 100 to an external recipient. By way of example, and not of limitation, in various embodiments, transceiver 113 comprises one or more of: a cellular transceiver, a wireless local area network transceiver (e.g., a transceiver compliant with one or more Institute of Electrical and Electronics Engineers (IEEE) 802.11 specifications for wireless local area network communication), a wireless personal area network transceiver (e.g., a transceiver compliant with one or more IEEE 802.15 specifications (or the like) for wireless personal area network communication), and a wired a serial transceiver (e.g., a universal serial bus for wired communication).

Ultrasonic transducer 150 is configured to emit and receive ultrasonic signals which are in the ultrasonic range. In some embodiments, a plurality of ultrasonic transducers 150 may be included and one may emit sonic signals while one or more others receive resulting signals from the emitted sonic signals. In some embodiments, ultrasonic transducer 150 may include a controller 151 for locally controlling the operation of the ultrasonic transducer 150. Additionally, or alternatively, in some embodiments, one or more aspects of the operation of ultrasonic transducer 150 or components thereof may be controlled by an external component such as host processor 110. Device 100A may contain a single ultrasonic transducer 150, or may contain a plurality of ultrasonic transducers, for example in the form of an array of ultrasonic transducers. For example, in an embodiment with a single ultrasonic transducer that is used for transmitting (e.g., emitting) and receiving, the ultrasonic transducer may be in an emitting phase for a portion of its duty cycle and in a receiving phase during another portion of its duty cycle. A known characteristic of sensors such as ultrasonic transducer 150 is that the signal exhibits very high initial amplitude that results from the vibration associated with emitting a pulse (in the emitting portion of its duty cycle) and perhaps shortly afterward due to the emission of the pulse. This vibration due to the emission of a pulse from a transducer is referred to as “ringdown.”

Controller 151, when included, may be any suitable controller, many types of which have been described herein. In some embodiments, controller 151 may control the duty cycle (emit or receive) of the ultrasonic transducer 150 and the timing of switching between emitting and receiving. In some embodiments, a controller 151 may perform some amount of the processing of received returned signals and/or some aspects of the methods of detecting obstruction of an ultrasonic transducer that are described herein. For example, controller 151 may implement the user presence algorithm alone or in conjunction with host processor 110.

FIG. 1B shows a block diagram of components of an example device 100B, in accordance with various aspects of the present disclosure. Device 100B is similar to device 100A except that it includes a sensor processing unit (SPU) 120 in which ultrasonic transducer 150 is disposed. SPU 120, when included, comprises: a sensor processor 130; an internal memory 140; and at least one ultrasonic transducer 150. Though not depicted, in some embodiments, SPU 120 may additionally include one or more motion sensors and/or one or more other sensors such a light sensor, infrared sensor, GNSS sensor, temperature sensor, barometric pressure sensor, microphone, an audio recorder, a camera, etc. In some embodiments, SPU 120 may trigger selective operation of some aspects of device 100 in response to detecting obstruction of ultrasonic transducer 150. As noted above, one potential function of ultrasonic transducer 150 is to determine whether a user is present. If ultrasonic transducer 150 is obstructed, it may not be able to reliably make this determination and device 100 may incorrectly operate as though the user is not present (e.g., power save mode may be enabled). However, once it has been determined ultrasonic transducer 150 is obstructed according to the techniques of this disclosure, this behavior may be modified as desired. As one illustration, user presence detection and its control over system functions may be suspended while the ultrasonic transducer 150 is obstructed to avoid reaching an incorrect determination that the user is not present. Similarly, user presence detection can subsequently be reenabled following a determination that ultrasonic transducer 150 has become unobstructed. In various embodiments, SPU 120 or a portion thereof, such as sensor processor 130, is communicatively coupled with host processor 110, host memory 111, and/or other components of device 100 through communications interface 105 or other well-known means. SPU 120 may also comprise one or more communications interfaces (not shown) similar to communications interface 105 and used for communications among one or more components within SPU 120.

Sensor processor 130 can be one or more microprocessors, CPUs, DSPs, general purpose microprocessors, ASICs, ASIPs, FPGAs or other processors that run software programs, which may be stored in memory such as internal memory 140 (or elsewhere), associated with the functions of SPU 120. In some embodiments, one or more of the functions described as being performed by sensor processor 130 may be shared with or performed in whole or in part by another processor of a device 100, such as host processor 110. In some embodiments, a sensor processor 130 may perform some amount of the processing of received returned signals and/or some aspects of the methods of detecting obstruction of an ultrasonic transducer.

Internal memory 140 can be any suitable type of memory, including but not limited to electronic memory (e.g., read only memory (ROM), random access memory (RAM), or other electronic memory). Internal memory 140 may store algorithms, routines, or other instructions for instructing sensor processor 130 on the processing of data output by one or more of ultrasonic transducer 150 and/or other sensors. In some embodiments, internal memory 140 may store one or more modules which may be algorithms that execute on sensor processor 130 to perform a specific function. Some examples of modules may include, but are not limited to: statistical processing modules, motion processing modules, object detection modules, object location modules, and/or decision-making modules. Modules may include instructions to implement one or more of the methods described herein using host processor 110, sensor processor 130, and or controller 151.

Ultrasonic transducer 150, as previously described, is configured to emit and receive ultrasonic signals which are in the ultrasonic range. In some embodiments, a plurality of ultrasonic transducers 150 may be included and one may emit sonic signals while one or more others receive resulting signals from the emitted sonic signals. In some embodiments, ultrasonic transducer 150 may include a controller 151 for locally controlling the operation of the ultrasonic transducer 150. Additionally, or alternatively, in some embodiments, one or more aspects of the operation of ultrasonic transducer 150 or components thereof may be controlled by an external component such as sensor processor 130 and/or host processor 110. Ultrasonic transducer 150 is communicatively coupled with sensor processor 130 by a communications interface (such as communications interface 105), bus, or other well-known communication means.

Controller 151, when included, may be any suitable controller, many types of which have been described herein. In some embodiments, controller 151 may control the duty cycle (emit or receive) of the ultrasonic transducer 150 and the timing of switching between emitting and receiving. In some embodiments, a controller 151 may perform some amount of the processing of received returned signals, may perform some aspects of the methods of detecting obstruction of an ultrasonic transducer that are described herein, and/or may interpret and carryout instructions received from external to ultrasonic transducer 150.

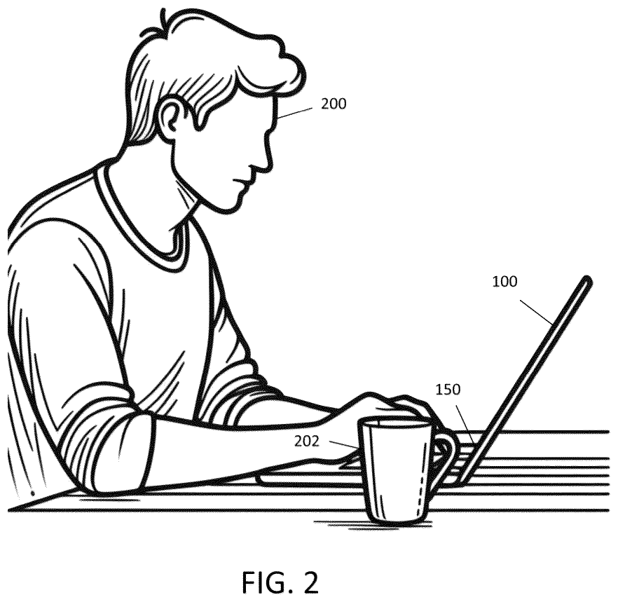

Turning now to FIG. 2, an exemplary use case is depicted of device 100, implemented here as a laptop computer, using a sonic transducer such as ultrasonic transducer 150 to detect objects, in accordance with various embodiments. Typical objects that may be detected include user 200 in order to infer that the user is interacting with device 100. As desired, ultrasonic transducer 150 may also detect other objects in the environment. As will discussed below, the techniques of this disclosure are directed to determining if ultrasonic transducer 150 is obstructed. For example, mug 202 may be inadvertently placed in a position that blocks ultrasonic transducer 150. Similar blockage may result if the user holds or carries the laptop or when the laptop is placed in a container.

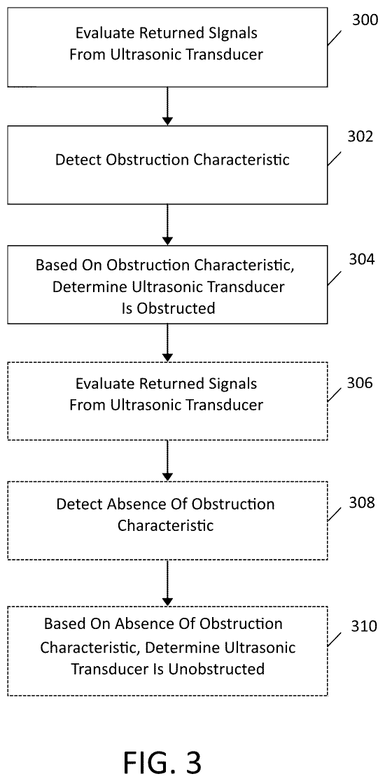

To help illustrate aspects of the disclosed techniques, FIG. 3 illustrates a flow diagram of a method of detecting obstruction of an ultrasonic transducer, in accordance with various embodiments. As noted above, an ultrasonic transducer is used to emit an ultrasonic pulse and receive returned signals corresponding to the emitted ultrasonic pulse. Correspondingly, beginning with 300, returned signals from a first plurality of emitted ultrasonic pulses are evaluated. Based on the evaluation, an obstruction characteristic is detected in 302. Then, it is determined based on the detected obstruction characteristic that the ultrasonic transducer is obstructed in 304. In some embodiments (as indicated by the dashed boxes), the method may also involve evaluating returned signals from a second plurality of emitted ultrasonic pulses subsequent to the first plurality in 306. An absence of the obstruction characteristic is detected based on the evaluation in 308. Namely, the returned signals from the second plurality of emitted ultrasonic pulses are evaluated to determine if the obstruction characteristic detected in 302 is now absent. In 310, the ultrasonic transducer is determined to be unobstructed based on the absence of the detected obstruction characteristic.

As will be appreciated, the parameters associated with the obstruction characteristic may be tuned to achieve the performance desired. As one example, the detection of the obstruction characteristic in 302 may be for the received signals from a first series of sequential ultrasonic pulses emitted over a first period of time. For the purposes of illustration and not limitation, the series of pulses may be 10 pulses, which may correspond to a period of time of 1 second at a sample rate of 10 Hz. Similar tuning may be performed for the absence of the obstruction characteristic detected in 308. Again, without limitation, characteristic may be absent for a second series of sequential ultrasonic pulses emitted over a second period of time, such as 4 samples over a period of 0.4 at the same sample rate. Further, different obstruction characteristics, alone or in combination, may be employed in making the determinations of this disclosure. Representative examples include an absence of an echo in the received signals above a noise level other than a ringdown amplitude, a variation in ringdown amplitude and a saturation of the received signals.

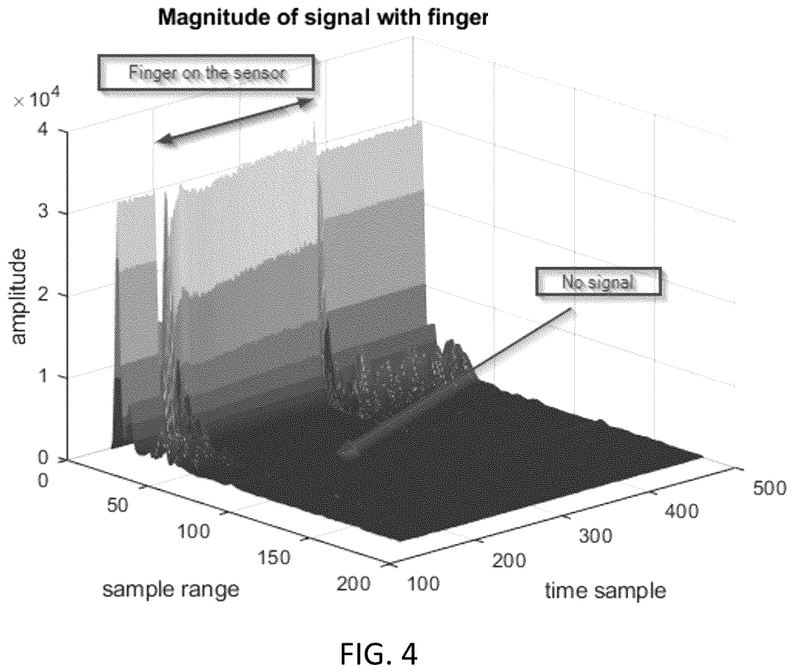

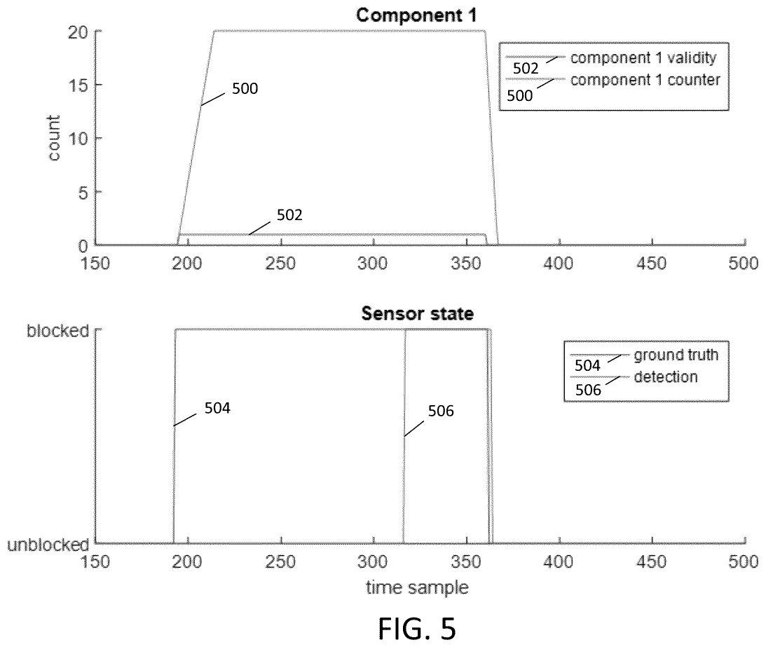

To help illustrate the absence of signal above noise level obstruction characteristic, FIG. 4 depicts a graph of raw magnitudes of returned signals received over a period of time by an ultrasonic transducer in a sensed environment such as a room. As can be seen, there is an absence of signal beyond the noise level from a certain range, which can result from the user placing a finger over the ultrasonic transducer or other similar conditions. This graph shows that the sensor was obstructed from approximately time sample 195 to 360. Although ringdown is present at all times, along with secondary signals, there is a lack of signal beyond this range, from approximately 30 cm on. The threshold to distinguish an echo from noise is a constant value that may be established based on the characteristics of the ultrasonic transducer. In comparison, there is residual signal above the noise floor as shown for the other time samples. Next, FIG. 5 is a state graph corresponding to evaluation of the samples shown in FIG. 4. The upper view shows an counter, indicated by trace 500, that begins incrementing upon detection of the absence of signal obstruction characteristic that is detectable for the time period shown by trace 502. The bottom view shows the output of the obstruction determination, with trace 504 representing the obstruction and trace 506 representing the determination. In this example, after the counter increments to a desired value (such as 10 samples as per the illustration given above), a declaration of obstruction can be made. Here, the further condition is imposed that no motion from the user is sensed, which occurs at sample 317 and results in the determination of obstruction as shown.

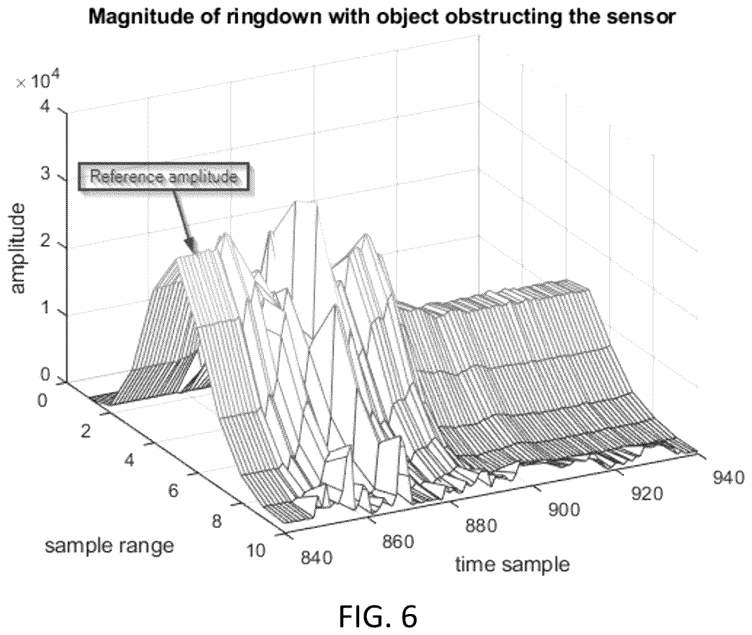

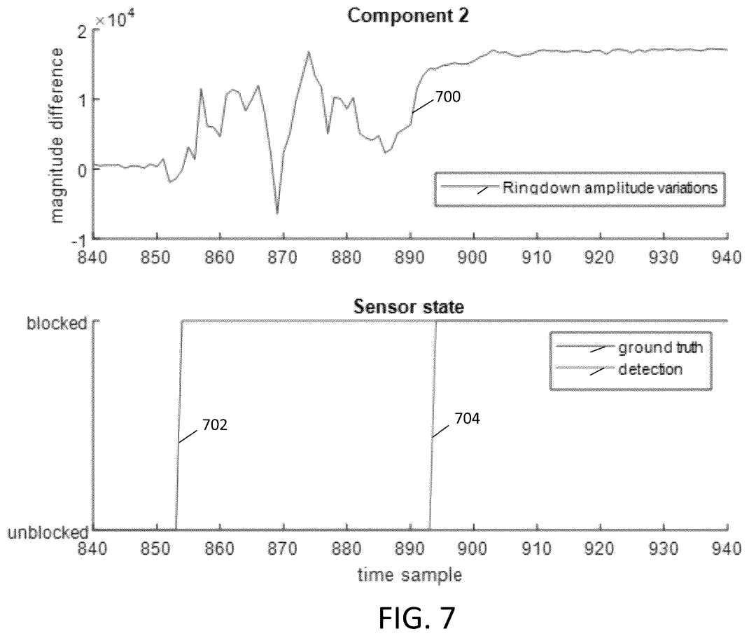

To help illustrate the ringdown variation obstruction characteristic, FIG. 6 depicts a graph of raw magnitudes of returned signals received over a period of time by an ultrasonic transducer in a sensed environment such as a room. The ringdown amplitude varies as a reflecting object approaches very close to the sensor (such as <3 cm). Since ringdown amplitude depends on environment factors such as temperature, a reference ringdown amplitude may be determined during prior operation. For example, the reference value may be established when a user is approaching the sensor and about to use the device at a reasonable distance (such more than 30 cm). Accordingly, by comparing the current ringdown amplitude with the reference, deviation indicates that the ultrasonic transducer is blocked. This graph shows that deviation from the reference ringdown amplitude begins at approximately time sample 850. A suitable threshold may be set to determine when the deviation is sufficient. As one illustration and without limitation, this obstruction characteristic may be considered detected when absolute difference is greater than 1000. Other values may be employed based on the desired performance characteristics. Next, FIG. 7 shows a plot of the ringdown amplitude difference with respect to reference as trace 700 in the upper view. is a state graph corresponding to evaluation of the samples shown in FIG. 5. The bottom view shows the output of the obstruction determination, with trace 702 representing the obstruction and trace 704 representing the determination. In this example, after the counter increments to a desired value (such as 10 samples as per the illustration given above), a declaration of obstruction can be made. As above, the further condition is imposed that no motion from the user is sensed, which occurs at sample 894 and results in the determination of obstruction as shown.

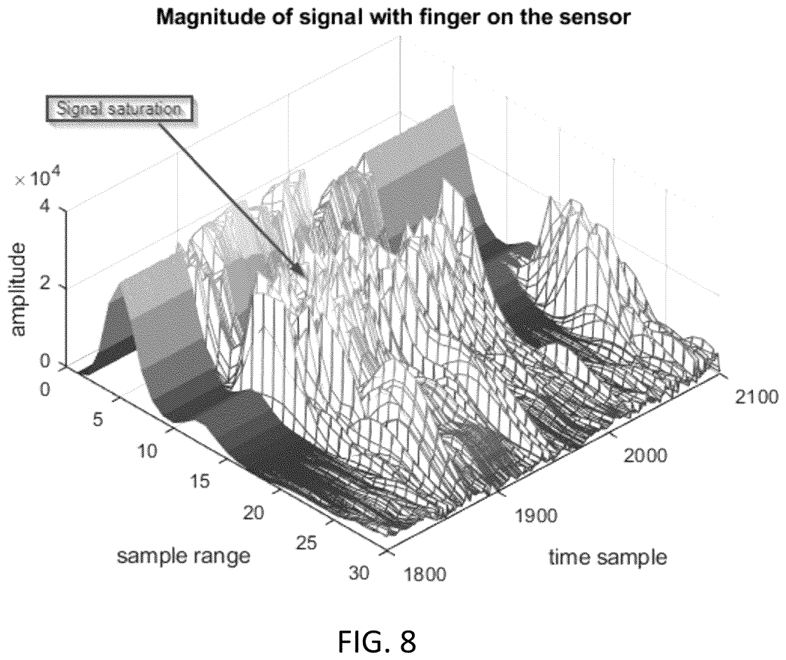

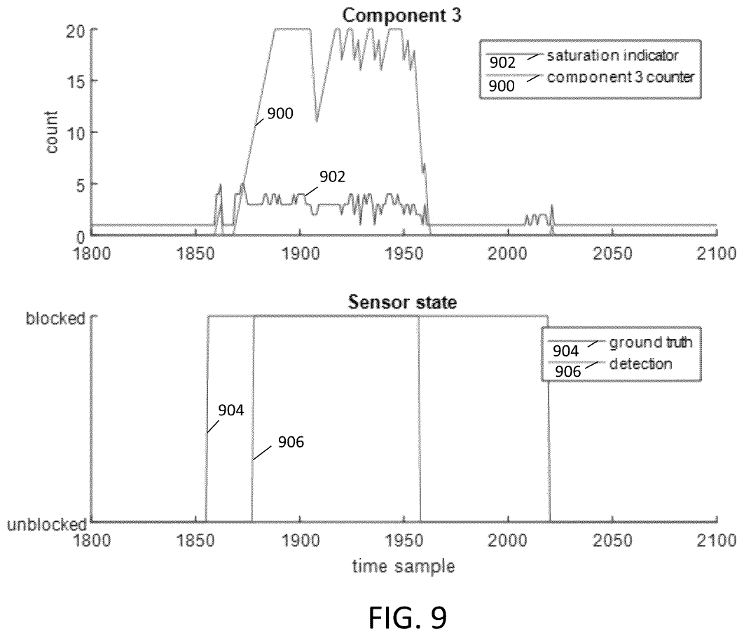

Still further, FIG. 10 depicts a graph of raw magnitudes of returned signals received over a period of time by an ultrasonic transducer in a sensed environment such as a room to help illustrate the signal saturation obstruction characteristic. Saturation of the signal may be detected right after the ringdown and taken to represent an object being very close to the sensor. In one embodiment, the saturation of the signal may be determined when at least two peaks of large amplitude occur after the ringdown and within a suitably close range, such as 20 cm for example. This graph shows that saturation begins at approximately time sample 1860. Correspondingly, FIG. 9 is a state graph corresponding to evaluation of the samples shown in FIG. 8. The upper view shows an counter, indicated by trace 900, that begins incrementing upon detection of the signal saturation, indicated by trace 902. The bottom view shows the output of the obstruction determination, with trace 904 representing the obstruction and trace 906 representing the determination. In this example, after the counter increments to a desired value (such as 10 samples as per the illustration given above), a declaration of obstruction can be made. Once more, the further condition is imposed that no motion from the user is sensed, which occurs at sample 1877 and results in the determination of obstruction as shown.

As noted above, an optional further aspect of the disclosure is the determination that the ultrasonic transducer has returned to an unobstructed state. Referring back to FIG. 3, this may involve evaluating in 308 the returned signals from the second plurality of emitted ultrasonic pulses to determine if the obstruction characteristic detected in 302 is absent. Notable examples of the obstruction characteristic include an absence of an echo in the received signals above a noise level other than a ringdown amplitude, a variation in ringdown amplitude and a saturation of the received signals. Additionally, it may be desirable to determine the ultrasonic transducer is unobstructed when the user is detected at an expected range, such as greater than approximately 30 cm. Similarly, it may be desirable to determine the ultrasonic transducer is unobstructed when any objects are detected at farther distances, regardless of the variation in ringdown amplitude and a saturation of the received signals.

In the described embodiments, a chip is defined to include at least one substrate typically formed from a semiconductor material. A single chip may be formed from multiple substrates, where the substrates are mechanically bonded to preserve the functionality. A multiple chip includes at least two substrates, wherein the two substrates are electrically connected, but do not require mechanical bonding. A package provides electrical connection between the bond pads on the chip to a metal lead that can be soldered to a PCB. A package typically comprises a substrate and a cover. Integrated Circuit (IC) substrate may refer to a silicon substrate with electrical circuits, typically CMOS circuits. In some configurations, a substrate portion known as a MEMS cap provides mechanical support for the MEMS structure. The MEMS structural layer is attached to the MEMS cap. The MEMS cap is also referred to as handle substrate or handle wafer. In the described embodiments, an electronic device incorporating a sensor may employ a sensor tracking module also referred to as Sensor Processing Unit (SPU) that includes at least one sensor in addition to electronic circuits. The sensor, such as a gyroscope, a magnetometer, an accelerometer, a microphone, a pressure sensor, a proximity sensor, or an ambient light sensor, among others known in the art, are contemplated. Some embodiments include accelerometer and gyroscope, which each provide a measurement along three axes that are orthogonal to each other. Such a device is often referred to as a 6-axis device. Other embodiments include accelerometer, gyroscope, and magnetometer, which each provide a measurement along three axes that are orthogonal to each other. Such a device is often referred to as a 9-axis device. Other embodiments may not include all the sensors or may provide measurements along one or more axes. The sensors may be formed on a first substrate. Other embodiments may include solid-state sensors or any other type of sensors. The electronic circuits in the SPU receive measurement outputs from the one or more sensors. In some embodiments, the electronic circuits process the sensor data. The electronic circuits may be implemented on a second silicon substrate. In some embodiments, the first substrate may be vertically stacked, attached and electrically connected to the second substrate in a single semiconductor chip, while in other embodiments, the first substrate may be disposed laterally and electrically connected to the second substrate in a single semiconductor package.

In one embodiment, the first substrate is attached to the second substrate through wafer bonding, as described in commonly owned U.S. Pat. No. 7,104,129, which is incorporated herein by reference in its entirety, to simultaneously provide electrical connections and hermetically seal the MEMS devices. This fabrication technique advantageously enables technology that allows for the design and manufacture of high performance, multi-axis, inertial sensors in a very small and economical package. Integration at the wafer-level minimizes parasitic capacitances, allowing for improved signal-to-noise relative to a discrete solution. Such integration at the wafer-level also enables the incorporation of a rich feature set which minimizes the need for external amplification.

In the described embodiments, raw data refers to measurement outputs from the sensors which are not yet processed. Motion data may refer to processed and/or raw data. Processing may include applying a sensor fusion algorithm or applying any other algorithm. In the case of a sensor fusion algorithm, data from a plurality of sensors may be combined to provide, for example, an orientation of the device. In the described embodiments, a SPU may include processors, memory, control logic and sensors among structures.

As discussed above, this disclosure is directed to a device having an ultrasonic transducer configured to emit an ultrasonic pulse and receive returned signals corresponding to the emitted ultrasonic pulse and at least one processor coupled with the ultrasonic transducer. The at least one processor may be configured to evaluate returned signals from a first plurality of emitted ultrasonic pulses, detect an obstruction characteristic based on the evaluation and determine the ultrasonic transducer is obstructed based on the detected obstruction characteristic.

In one aspect, the at least one processor may be configured to determine the ultrasonic transducer is obstructed when the obstruction characteristic is detected for a first series of sequential ultrasonic pulses emitted over a first period of time.

In one aspect, the at least one processor may also be configured to evaluate returned signals from a second plurality of emitted ultrasonic pulses subsequent to the first plurality, detect an absence of the obstruction characteristic based on the evaluation and determine the ultrasonic transducer is unobstructed based on the absence of the detected obstruction characteristic. The at least one processor may be configured to determine the ultrasonic transducer is unobstructed when the obstruction characteristic is absent for a second series of sequential ultrasonic pulses emitted over a second period of time.

In one aspect, the detected obstruction characteristic is the same for the returned signals from the first plurality of emitted ultrasonic pulses and is at least one of:
i) an absence of an echo in the received signals above a noise level other than a ringdown amplitude;
ii) a variation in ringdown amplitude; and
iii) a saturation of the received signals.

In one aspect, the detected obstruction characteristic may be an absence of an echo in the received signals beyond a threshold range.

In one aspect, the detected obstruction characteristic may be a variation in ringdown amplitude, such that the at least one processor may be configured to determine a reference ringdown amplitude based on previous usage.

In one aspect, the detected obstruction characteristic is a saturation of the received signals within a threshold range.

Further, this disclosure also is directed to a sensor processing unit having an ultrasonic transducer configured to emit an ultrasonic pulse and receive returned signals corresponding to the emitted ultrasonic pulse and at least one sensor processor coupled with the ultrasonic transducer and configured to evaluate returned signals from a first plurality of emitted ultrasonic pulses, detect an obstruction characteristic based on the evaluation and determine the ultrasonic transducer is obstructed based on the detected obstruction characteristic.

In one aspect, the at least one processor may be configured to determine the ultrasonic transducer is obstructed when the obstruction characteristic is detected for a first series of sequential ultrasonic pulses emitted over a first period of time.

In one aspect, the at least one processor may also be configured to evaluate returned signals from a second plurality of emitted ultrasonic pulses subsequent to the first plurality, detect an absence of the obstruction characteristic based on the evaluation and determine the ultrasonic transducer is unobstructed based on the absence of the detected obstruction characteristic. The at least one processor may be configured to determine the ultrasonic transducer is unobstructed when the obstruction characteristic is absent for a second series of sequential ultrasonic pulses emitted over a second period of time.

In one aspect, the detected obstruction characteristic is the same for the returned signals from the first plurality of emitted ultrasonic pulses and is at least one of:
i) an absence of an echo in the received signals above a noise level other than a ringdown amplitude;
ii) a variation in ringdown amplitude; and
iii) a saturation of the received signals.

In one aspect, the detected obstruction characteristic may be an absence of an echo in the received signals beyond a threshold range.

In one aspect, the detected obstruction characteristic may be a variation in ringdown amplitude, such that the at least one processor may be configured to determine a reference ringdown amplitude based on previous usage.

In one aspect, the detected obstruction characteristic is a saturation of the received signals within a threshold range.

Further, this disclosure is also directed to a method for determining an ultrasonic sensor is obstructed. The method may involve evaluating with at least one processor coupled with an ultrasonic transducer returned signals from a first plurality of emitted ultrasonic pulses, detecting an obstruction characteristic based on the evaluation and determining the ultrasonic transducer is obstructed based on the detected obstruction characteristic.

In one aspect, it may be determined the ultrasonic transducer is obstructed when the obstruction characteristic is detected for a first series of sequential ultrasonic pulses emitted over a first period of time.

In one aspect, the method may also involve evaluating returned signals from a second plurality of emitted ultrasonic pulses subsequent to the first plurality, detecting an absence of the obstruction characteristic based on the evaluation and determining the ultrasonic transducer is unobstructed based on the absence of the detected obstruction characteristic. The ultrasonic transducer may be determined to be unobstructed when the obstruction characteristic is absent for a second series of sequential ultrasonic pulses emitted over a second period of time.

In one aspect, the detected obstruction characteristic is the same for the returned signals from the first plurality of emitted ultrasonic pulses and is at least one of:
i) an absence of an echo in the received signals above a noise level other than a ringdown amplitude;
ii) a variation in ringdown amplitude; and
iii) a saturation of the received signals.

In one aspect, the detected obstruction characteristic may be an absence of an echo in the received signals beyond a threshold range.

In one aspect, the detected obstruction characteristic may be a variation in ringdown amplitude, such that a reference ringdown amplitude is determined based on previous usage.

In one aspect, the detected obstruction characteristic is a saturation of the received signals within a threshold range.

Although the present invention has been described in accordance with the embodiments shown, one of ordinary skill in the art will readily recognize that there may be variations to the embodiments and those variations would be within the spirit and scope of the present invention. One skilled in the art may readily devise other systems consistent with the disclosed embodiments which are intended to be within the scope of this disclosure.

What is claimed is:

1. A device comprising:
an ultrasonic transducer configured to emit an ultrasonic pulse and receive returned signals corresponding to the emitted ultrasonic pulse; and
at least one processor coupled with the ultrasonic transducer and configured to:
evaluate returned signals from a first plurality of emitted ultrasonic pulses;
detect an obstruction characteristic based on the evaluation; and
determine the ultrasonic transducer is obstructed based on the detected obstruction characteristic.

2. The device of claim 1, wherein the at least one processor is configured to determine the ultrasonic transducer is obstructed when the obstruction characteristic is detected for a first series of sequential ultrasonic pulses emitted over a first period of time.

3. The device of claim 1, wherein the at least one processor is further configured to:
evaluate returned signals from a second plurality of emitted ultrasonic pulses subsequent to the first plurality;
detect an absence of the obstruction characteristic based on the evaluation; and
determine the ultrasonic transducer is unobstructed based on the absence of the detected obstruction characteristic.

4. The device of claim 3, wherein the at least one processor is configured to determine the ultrasonic transducer is unobstructed when the obstruction characteristic is absent for a second series of sequential ultrasonic pulses emitted over a second period of time.

5. The device of claim 1, wherein the detected obstruction characteristic is the same for the returned signals from the first plurality of emitted ultrasonic pulses and is at least one of:
i) an absence of an echo in the received signals above a noise level other than a ringdown amplitude;
ii) a variation in ringdown amplitude; and
iii) a saturation of the received signals.

6. The device of claim 5, wherein the detected obstruction characteristic is an absence of an echo in the received signals beyond a threshold range.

7. The device of claim 5, wherein the detected obstruction characteristic is a variation in ringdown amplitude, further comprising the at least one processor being configured to determine a reference ringdown amplitude based on previous usage.

8. The device of claim 5, wherein the detected obstruction characteristic is a saturation of the received signals within a threshold range.

9. A sensor processing unit comprising:
an ultrasonic transducer configured to emit an ultrasonic pulse and receive returned signals corresponding to the emitted ultrasonic pulse; and
at least one sensor processor coupled with the ultrasonic transducer and configured to:
evaluate returned signals from a first plurality of emitted ultrasonic pulses;
detect an obstruction characteristic based on the evaluation; and
determine the ultrasonic transducer is obstructed based on the detected obstruction characteristic.

10. The sensor processing unit of claim 9, wherein the at least one processor is configured to determine the ultrasonic transducer is obstructed when the obstruction characteristic is detected for a first series of sequential ultrasonic pulses emitted over a first period of time.

11. The sensor processing unit of claim 9, wherein the at least one processor is further configured to:
evaluate returned signals from a second plurality of emitted ultrasonic pulses subsequent to the first plurality;
detect an absence of the obstruction characteristic based on the evaluation; and
determine the ultrasonic transducer is unobstructed based on the absence of the
detected obstruction characteristic.

12. The sensor processing unit of claim 9, wherein the at least one processor is configured to determine the ultrasonic transducer is unobstructed when the obstruction characteristic is absent for a second series of sequential ultrasonic pulses emitted over a second period of time.

13. The sensor processing unit of claim 9, wherein the detected obstruction characteristic is the same for the returned signals from the first plurality of emitted ultrasonic pulses and is at least one of:
i) an absence of an echo in the received signals above a noise level other than a ringdown amplitude;
ii) a variation in ringdown amplitude; and
iii) a saturation of the received signals.

14. The sensor processing unit of claim 9, wherein the detected obstruction characteristic is an absence of an echo in the received signals beyond a threshold range.

15. The sensor processing unit of claim 9, wherein the detected obstruction characteristic is a variation in ringdown amplitude, further comprising the at least one processor being configured to determine a reference ringdown amplitude based on previous usage.

16. The sensor processing unit of claim 9, wherein the detected obstruction characteristic is a saturation of the received signals within a threshold range.

17. A method for determining an ultrasonic sensor is obstructed, comprising: evaluating, employing at least one processor coupled with an ultrasonic transducer, returned signals from a first plurality of emitted ultrasonic pulses;
detecting an obstruction characteristic based on the evaluation; and
determining the ultrasonic transducer is obstructed based on the detected obstruction characteristic.

18. The method of claim 17, wherein determining the ultrasonic transducer is obstructed occurs when the obstruction characteristic is detected for a first series of sequential ultrasonic pulses emitted over a first period of time.

19. The method of claim 17, further comprising:
evaluating returned signals from a second plurality of emitted ultrasonic pulses subsequent to the first plurality;
detecting an absence of the obstruction characteristic based on the evaluation; and
determining the ultrasonic transducer is unobstructed based on the absence of the detected obstruction characteristic.

20. The method of claim 19, wherein determining the ultrasonic transducer is unobstructed occurs when the obstruction characteristic is absent for a second series of sequential ultrasonic pulses emitted over a second period of time.

21. The method of claim 17, wherein the detected obstruction characteristic is the same for the returned signals from the first plurality of emitted ultrasonic pulses and is at least one of:
i) an absence of an echo in the received signals above a noise level other than a ringdown amplitude;
ii) a variation in ringdown amplitude; and
iii) a saturation of the received signals.

22. The method of claim 21, wherein the detected obstruction characteristic is an absence of an echo in the received signals beyond a threshold range.

23. The method of claim 21, wherein the detected obstruction characteristic is a variation in ringdown amplitude and wherein a reference ringdown amplitude is determined based on previous usage.

24. The method of claim 21, wherein the detected obstruction characteristic is a saturation of the received signals within a threshold range.
